(19) United States
(12) Patent Application Publication
(10) Pub. No.: US 2023/0169638 A1
(43) Pub. Date: Jun. 1, 2023

(54) AUTOMATIC QUALITY CATEGORIZATION METHOD AND SYSTEM FOR PHARMACEUTICAL GLASS CONTAINERS

(71) Applicant: CORNING INCORPORATED, Corning, NY (US)

(72) Inventors: Michael Allen Motyka, Painted Post, NY (US); Helen HaeKyung Shin, Fairport, NY (US)

(21) Appl. No.: 17/994,900

(22) Filed: Nov. 28, 2022

Related U.S. Application Data
(60) Provisional application No. 63/283,746, filed on Nov. 29, 2021.

(51) Int. Cl. G06T 7/00

(52) U.S. Cl. CPC G06T 7/0004; G06T 2207/20081; G06T 2207/20084

(57) ABSTRACT

A vial coating quality inspection system comprises a vial coating quality measurement system comprising one or more imaging components for capturing images of a region of interest on a coated vial, and a processor configured to receive image data transmitted from the one or more imaging components. A method of inspecting quality of an exterior coating on a vial comprises obtaining a coating quality measurement of the vial exterior coating using optical reflectance imaging; transmitting the raw coating quality measurement data to a processor; and displaying the captured vial image and classification and prediction output from the processor. The processor preprocesses the raw measurement data and inputs the preprocessed data to a classification prediction model, the classification prediction model is updated using training data, the coating quality is classified based on the prediction model.

This application claims the benefit of priority under 35 U.S.C. § 119 of U.S. Provisional Application Ser. No. 63/283,746 filed on Nov. 29, 2021, the content of which is relied upon and incorporated herein by reference in its entirety.

### FIELD OF THE DISCLOSURE

This disclosure generally relates to quality categorization methods and systems and particularly relates to quality categorization methods and systems for pharmaceutical glass containers.

### BACKGROUND

Valor Glass (Corning Incorporated, Corning, N.Y.) is a tubular glass packaging solution with Type I hydrolytic performance that substantially reduces particle contamination and prevents cracks. Valor Glass may be formed into glass vials (Corning Incorporated, Corning, N.Y.) designed for pharmaceutical usage and optimized to resist breakage and prevent cracks through ion exchange strengthening and a thermally stable exterior coating. Such an exterior coating on Valor Glass vials is applied only to the outside of the vial, so there is no increased risk with respect to extractables and leachables. The external coating reduces the coefficient of friction of the vials, allowing them to process with less resistance on a filling line than conventional borosilicate vials.

The evaluation of the coating quality is typically conducted through visual inspection by skilled personnel, wherein the skilled personnel perform visual tests for different defect types. Though skilled personnel may have a reference set for coating quality limits for different defect types for visual tests, the human component presents unavoidable variability during visual inspection of the coating quality. A need exists for an automated or automatic qualitative method and system for inspection, evaluation, and categorization of pharmaceutical vial coating quality.

### SUMMARY

In an aspect of the present disclosure, a vial coating inspection system is provided. The vial coating inspection system comprises a vial coating quality measurement system comprising one or more imaging components for capturing images of a region of interest on a vial, the vial comprising a coating, and a processor configured to receive image data transmitted from the one or more imaging components.

In an embodiment, the coating comprises an exterior coating or a coating disposed on an exterior surface of the vial. In an embodiment, the vial coating inspection system ensures consistency in coating quality for manufactured vials.

In an embodiment, each imaging component of the one or more imaging components comprises a camera.

In an embodiment, each camera captures images of a region of interest on a manufactured vial. In an embodiment, the vial is rotated about a central axis and images of the exterior coating of the vial are captured by the one or more imaging components. In an embodiment, the region of interest on the vial comprises a neck of the vial. In an embodiment, the region of interest on the vial comprises a shoulder of the vial. In an embodiment, the region of interest on the vial comprises a sidewall top middle region of the vial. In an embodiment, the region of interest on the vial comprises a sidewall middle region of the vial. In an embodiment, the region of interest on the vial comprises a sidewall bottom middle region of the vial. In an embodiment, the region of interest on the vial comprises a heel of the vial.

In an embodiment, the vial is a pharmaceutical grade vial. In an embodiment, the vial is a transparent glass vial. In an embodiment, the vial is a transparent plastic vial.

In an embodiment, a size of the vial comprises an ISO format vial size or a custom format vial size. In an embodiment, the ISO format vial size comprises a 2 R vial, 4 R vial, 6 R vial, 8 R vial, 10 R vial, 15 R vial, 20 R vial, 25 R vial, 30 R vial, 50 R vial, or 100 R vial. In an embodiment, the custom format vial size comprises a 3 ml vial, 10 ml vial, or 25 ml vial.

In an embodiment, the vial coating quality measurement system comprises a bench measurement system. In an embodiment, the bench measurement system comprises filter techniques to evaluate coating and texture quality. In an embodiment, the filter technique comprises a bright field filter technique. In an embodiment, the filter technique comprises a dark field filter technique. In an embodiment, the filter technique comprises a reflected filter technique.

In an aspect of the present disclosure, a method of inspecting quality of an exterior coating on a vial is provided. The method comprises obtaining a coating quality measurement of the vial exterior coating using optical reflectance imaging; transmitting the raw coating quality measurement data to a processor; and displaying the captured vial image and classification and prediction output from the processor.

In an embodiment, the processor preprocesses the raw measurement data and inputs the preprocessed data to a classification prediction model.

In an embodiment, the method further comprises adjusting a threshold value that determines the sub-category of vial classification.

In an embodiment, the method further comprises updating the classification prediction model using training data.

In an embodiment, a machine learning based prediction model is used that is generated by pre-trained sample sets.

In an embodiment, the method further comprises classifying the coating quality based on the updated prediction model.

In an embodiment, the method further comprises outputting the classification and probability from the processor. In an embodiment, the classification is selected from good, limit good, and bad. In an embodiment, the classification comprises coating quality based on coating quality of different regions of the vial. In an embodiment, the classification comprises coating quality based on coating defect type.

In an embodiment, obtaining a coating measurement further comprises capturing images of a region of interest on a coated vial; applying a filter technique to create a filtered image using optical reflectance; and obtaining measurement data from the filtered image.

In an embodiment, the method further comprises categorizing vial coating quality without human visual inspection.

In an embodiment, the regions of interest are selected from the shoulder, the body and/or neck, and the heel of a vial. In an embodiment, capturing images of the region of interest on the coated vial comprises capturing images while the vial rotates.

In an embodiment, the coated vial is positioned so that a bottom of the vial is in contact with a horizontal surface of a measurement system and the body of the vial is rotating 360 degrees about a cylindrical axis in a clockwise or counterclockwise manner.

In an embodiment, the measurement data comprises exterior coating quality metric values. In an embodiment, the exterior coating quality metric values comprise entropy, maximum intensity, minimum intensity, mean and standard deviation of intensity level, Ra, Rq, skewness, and kurtosis.

In an embodiment, the exterior coating quality metric values are a function of color channels. In an embodiment, the color channels are selected from Gray channel, B channel, Gray scaled channel, B scaled channel, or a combination thereof.

Additional aspects of the present disclosure will be set forth, in part, in the detailed description, figures and any claims which follow, and in part will be derived from the detailed description, or can be learned by practice of the disclosure. It is to be understood that both the foregoing general description and the following detailed description are exemplary and explanatory only and are not restrictive of the disclosure as disclosed.

### BRIEF DESCRIPTION OF THE DRAWINGS

FIG. 1 shows an image of a schematic cross section of a vial according to an embodiment of the present disclosure.

FIG. 2 shows an image of a bench measurement system according to an embodiment of the present disclosure.

FIG. 3 shows a sliced vial sample image and measurement area for a bench measurement system according to an embodiment of the present disclosure.

FIG. 4 shows a schematic diagram of prediction model generation and test flow according to an embodiment of the present disclosure.

FIG. 5 shows a sliced vial sample image and measurement area for prediction model input according to an embodiment of the present disclosure.

FIG. 6 shows a schematic diagram of the workflow to balance training samples using a heuristic self-training technique according to an embodiment of the present disclosure.

FIG. 7 shows a graphical image of cross correlation of input variables for vial coating quality metric for the B channel according to an embodiment of the present disclosure.

FIG. 8 shows a graphical image of cross correlation of input variables for vial coating quality metric for the Gray channel according to an embodiment of the present disclosure.

FIG. 9 shows a graphical image of SHAP feature importance ranking using Random Forest Model according to an embodiment of the present disclosure.

FIG. 10 shows a graphical image of SHAP feature importance ranking using XGBoost Tree Model according to an embodiment of the present disclosure.

FIG. 11 shows a schematic of a final ensemble prediction model workflow with different types of vial products according to an embodiment of the present disclosure.

FIG. 12 shows a schematic of an implementation workflow for coating quality evaluation system according to an embodiment of the present disclosure.

FIG. 13 shows a vial coating inspection system according to an embodiment of the present disclosure.

FIG. 14 depicts an example of internal hardware that may be used to implement the various computer processes and systems according to an embodiment of the present disclosure.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

Systems and methods as described herein allow for a fast, automatic way of categorizing vial coating quality samples without human visual inspection. The systems and methods allow for evaluating the coating quality of new vial samples using a machine learning (ML) based prediction model that is generated by pre-trained sample sets. As such, the systems and methods described herein may greatly reduce the inspection time by humans to categorize vials into sub-categories, to identify limit samples, and to deliver the acceptable vial samples to a user or customer quickly.

In some embodiments, the exterior coating to be inspected, evaluated, and categorized may be for a pharmaceutical article formed from a glass material. In some embodiments, the manufactured pharmaceutical article may comprise a glass vial having any suitable glass composition. For example, the vial may comprise a pharmaceutical grade glass vial. In an embodiment, the pharmaceutical grade glass vial may comprise a Valor Glass vial (Corning Incorporated, Corning, N.Y.).

In some embodiments, the exterior coating to be inspected, evaluated, and categorized may be for a pharmaceutical article formed from a plastic or polymeric material.

As a nonlimiting example, the manufactured vials to be inspected may be pharmaceutical grade plastic vials. The plastic or polymeric material may comprise polystyrene, polymethylmethacrylate, polyvinyl chloride, polycarbonate, polysulfone, polystyrene copolymers, fluoropolymers, polyesters, polyamides, polystyrene butadiene copolymers, fully hydrogenated styrenic polymers, polycarbonate PDMS copolymers, and polyolefins such as polyethylene, polypropylene, polymethyl pentene, polypropylene copolymers and cyclic olefin copolymers.

Embodiments of the coating quality inspection system and methods may be applicable for any suitable type of medical cartridge. Nonlimiting examples include medical grade or pharmaceutical grade vials, such as vials for injectables (crimp neck, double chamber) and vials for non-injectables (threaded neck, flip cap). In an embodiment, the medical cartridge is a glass vial. In an embodiment, the medical cartridge is a plastic vial.

Embodiments of the systems and methods described herein may be applicable for any suitable vial size. For example, the vial size may be a standard vial size or a custom vial size. Nonlimiting examples of standard vial sizes include ISO formats and custom formats. Nonlimiting examples of ISO formats comprise sizes 2 R, 4 R, 6 R, 8 R, 10 R, 15 R, 20 R, 25 R, 30 R, 50 R, and 100 R. Nonlimiting examples of custom formats comprise sizes 3 ml, 5 ml, and 7 ml. In some embodiments, the ISO format vial size comprises a 2 R vial, 4 R vial, 6 R vial, 8 R vial, 10 R vial, 15 R vial, 20 R vial, 25 R vial, 30 R vial, 50 R vial, or 100 R vial. In some embodiments, the custom format vial size comprises a 3 ml vial, 105 ml vial, or 725 ml vial.

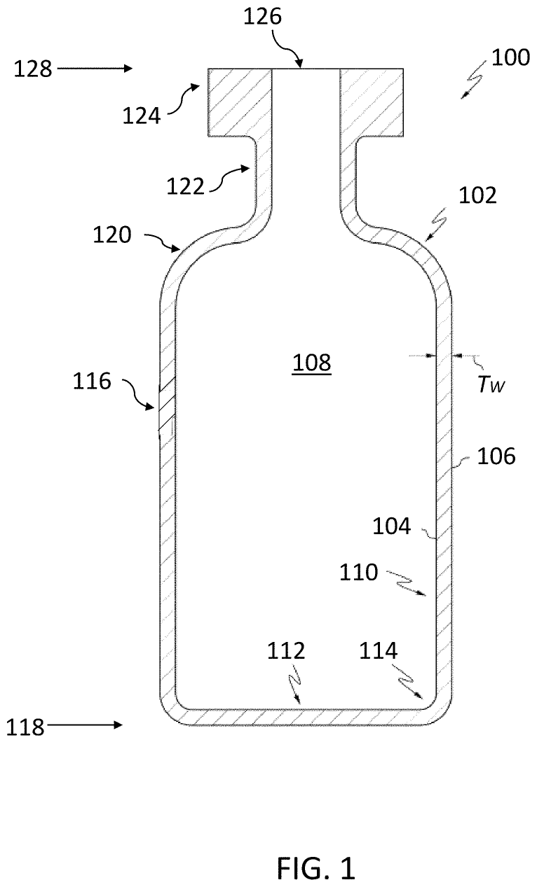

Referring to FIG. 1, a vial 100 is schematically depicted in cross section. In embodiments, the vial is a glass vial with a curved cylindrical shape, such as a glass vial for storing a pharmaceutical formulation. Although various embodiments described such glass vials, it is further contemplated that the methodologies described may be implemented in other types of containers, such as plastic vials or the like. The vial 100 generally comprises a body 102. The body 102 extends between an interior surface 104 and an exterior surface 106 and generally encloses an interior volume 108. The body 102 generally comprises a top portion 128, a wall or sidewall 110, and a floor 112 at a bottom 118 of the calibration standard. At the top portion 128 of the vial 100, the body 102 transitions from a flange 124 having an opening 126 into the interior volume 108, to a neck 122, and to a shoulder 120, before the body 102 transitions into the wall 110. The wall 110 transitions into the floor 112 through a heel portion 114. The body 102 has a wall thickness Tw which extends between the interior surface 104 and the exterior surface 106. The vial 100 also includes exterior coating 116 on the exterior surface 106 of the vial 100.

Glass Vials Coating Quality Measurement System

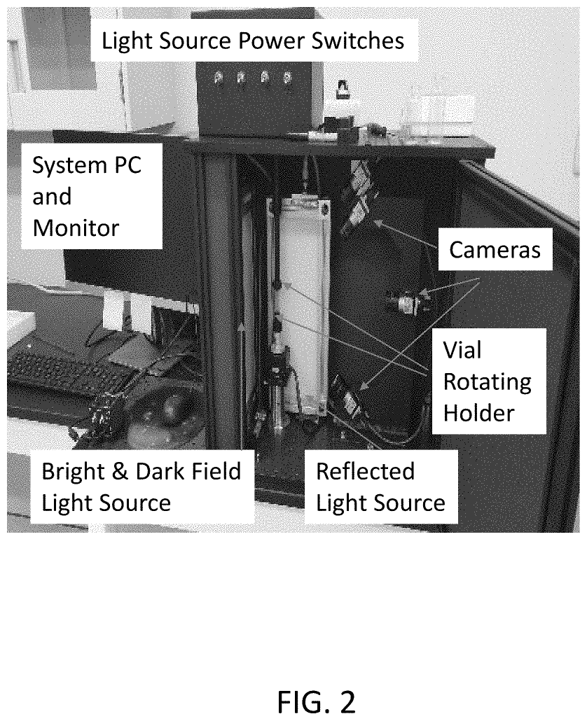

In an embodiment, a measurement system is provided to assess the cosmetic coating quality of pharmaceutical glass vials. FIG. 2 shows an image of a bench (or benchtop) measurement system. In an embodiment, the measurement system may be a bench measurement system. The bench measurement system may be configured to obtain and output metrics that measure the coating quality of the surfaces of the vials. For example, as shown in FIG. 2, the measurement system may comprise a vial holder (such as a rotating vial holder), one or more cameras, one or more light sources (such as a reflected light source, a bright field light source, and/or a dark field light source), power switches for the one or more light sources, and a controller, processor, computer, and/or display (such as a system PC and monitor). Optionally, the components may include a housing. The vial holder, one or more cameras, and one or more light sources may be disposed within the housing. The housing may have a door or lid for inserting and removing sample vials. When the door to the housing is closed, testing may be carried out using a light source of the one or more light sources without interruption by or interference from external light sources. The components disposed within the housing may be configured to communicate with components external to the housing, such as the power switches for the one or more light sources and a controller, processor, computer, and/or display (such as a system PC and monitor).

In an embodiment, the output metrics that measure the coating quality of the surfaces of the vials come from the profile parameters described in ISO 4287, which is the master standard for profile parameters in the ISO GPS system and defines terms and provides definitions for common parameters. Profile parameters from ISO 4287include amplitude parameters, spatial parameters, hybrid parameters, and functional parameters. Amplitude parameters include Rt (total height of the profile: height between the deepest valley and the highest peak on the evaluation length), Rp (maximum profile peak height: height of the highest peak from the mean line, defined on the sampling length), Rv (maximum profile valley depth: depth of the deepest valley from the mean line, defined on the sampling length), Rz (maximum height of the profile: defined on the sampling length), Ra (arithmetic mean deviation of the assessed profile: defined on the sampling length), Rq (root mean square deviation of the assessed profile: corresponds to the standard deviation of the height distribution, defined on the sampling length), Rsk (skewness of the assessed profile: asymmetry of the height distribution, defined on the sampling length), Rku (kurtosis of the assessed profile: sharpness of the height distribution, defined on the sampling length), and Rc (mean height of profile elements: defined on the evaluation length). Spatial parameters include Rsm (mean spacing of profile elements, defined on the evaluation length). Hybrid parameters include Rdq (root mean square slope of the assessed profile, defined on the sampling length) and Rpc (peak count number, which provides the density of peaks per unit of length). Functional parameters include Rmr (material ratio at a given depth, which gives the percentage of material cut at a given depth from the top of the profile) and Rdc (profile section height between two material ratios).

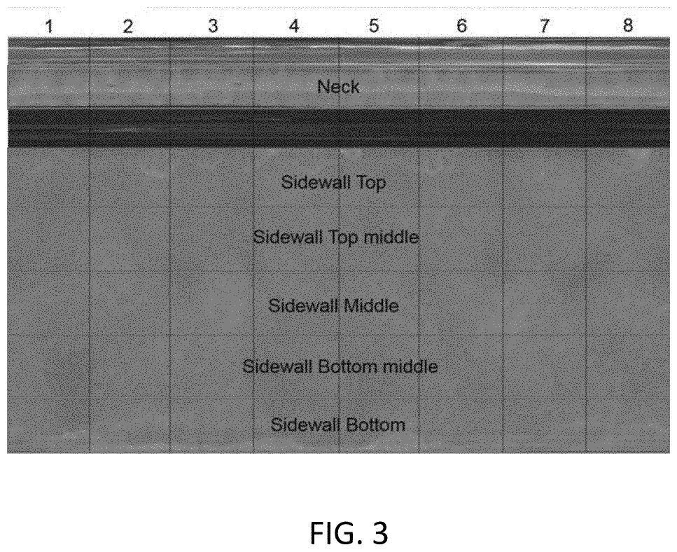

The bench measurement system is configured to apply different filter techniques to evaluate coating and texture quality. In an embodiment, the different filter techniques may include a bright field, a dark field, and a “COSMOS” or reflected filter techniques. The measurement system may comprise a plurality of cameras positioned to capture images of different areas or regions of a vial. For example, the measurement system may comprise three cameras positioned to capture images of shoulder, body/neck, and heel areas of a vial. Resulting from each single measurement taken are about 1000 measurements which are a function of the given channel (RGB, grayscale, B-channel, etc.). The chosen filter technique is then applied to create the image. Imaging software, such as on desktop server, operates the optical system and produces the measurement output from the sliced sample image shown in FIG. 3.

If the feasibility of providing the quality factor that maps between the sub-category of visual inspection and the coating quality measurement could be proven, this would result in establishing a quantitative metric that is based on the measurement with less visual inspection. Thus, systems and methods as described herein allow for an increase in productivity and decrease in variability in vial coating quality inspection. The systems and methods described herein establish an inspection system by predicting the classification of coating quality using a machine learning (ML) based model between the prior rankings of visual inspection and the measurement from the spectral imaging system.

An aspect of the present subject matter is directed to methods and systems that automatically classify the cosmetic exterior coating quality of pharmaceutical grade vials. The automatic classification by the inspection system designates sub-categories as good, limit good, and bad and generates the set of coating quality samples of different categories. Methods for classifying the exterior coating quality as described herein use a prediction model is developed for the relationship between measurements from the optical measurement bench system and the ranking using machine learning classification techniques. The ranking of the training set is collected by the visual inspection of skilled operators.

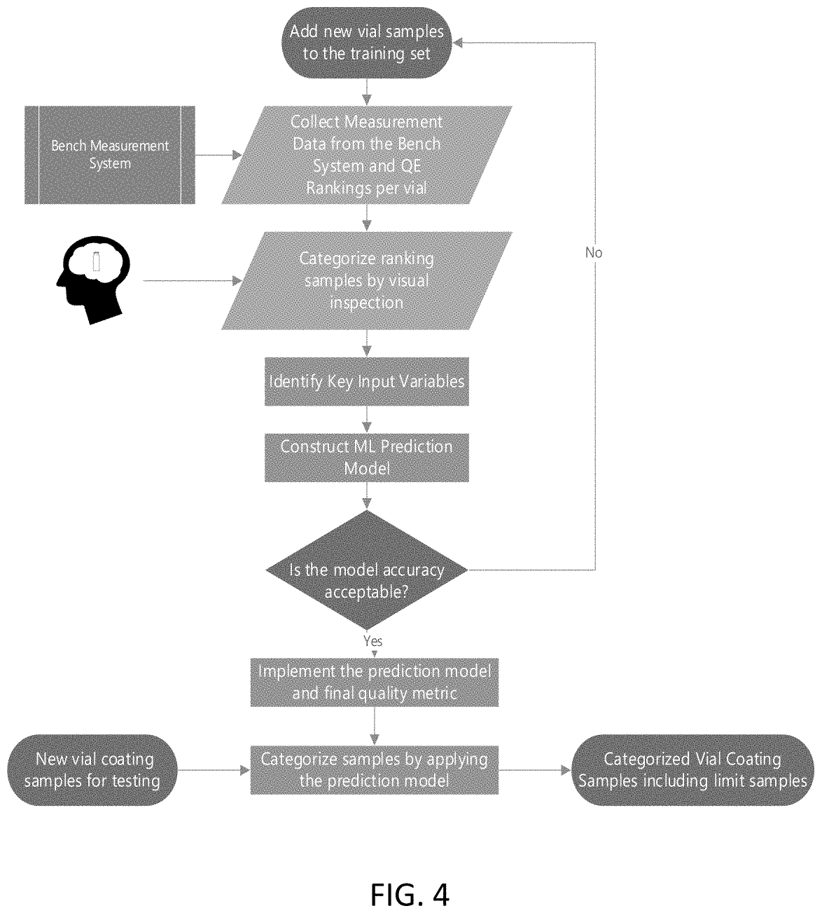

FIG. 4 shows the overall schematic diagram of the prediction model generation. The workflow includes several steps. Step 1 includes collecting and segmenting the coating quality measurement of vial samples and their rankings that are predetermined by a human. Step 2 includes selecting key input variables for the relationship between the measurement and the ranking using ML techniques. Step 3 includes constructing the prediction model using ML classification techniques. Step 4 includes optimizing the process until the desired accuracy is achieved. Step 5 includes calculating final ranking per vial by implementing the final quality algorithm to the prediction model. Step 6 includes applying the model to new incoming vial samples and dividing samples into each category. Step 7 includes extending the model and workflow to different types of vials using ML ensemble techniques.

The proposed workflow may be implemented as a standalone software module, such as software developed in the python language, that allows a quality metric output result to be obtained quickly and automatically. As such, methods and systems described herein no longer require waiting for the quality output to be completed by visual evaluation by a human, resulting in shortened cycle times for the process from the measurement step to the quality metric output for vial coating samples.

Systems and methods as described herein allow for ease in expanding the current workflow to different coating qualities and defect types of vials. The method uses ensemble machine learning techniques that aggregate different classification models for different types of vials and generate a final, combined model. As such, the method may easily be extended to inspect coating quality of different regions of vials or different coating defect types. The final prediction model is constructed by combining different techniques of machine learning classification models with adjusted weights for different models.

Systems and methods as described herein allow for ease in adjusting the predicted inspection result based on a user or customer requirement. For example, the threshold value that determines the sub-category of vial samples can be easily adjusted based on a user or customer requirement. This is possible because the final output provides the category with a confidence level. Moreover, the same samples may easily be categorized for different users or customers by changing the threshold value in order to shift the confidence level.

Systems and methods as described herein allow for solving of the imbalanced training sample size for the prediction model using self training ML techniques. It is important to have the training set with balanced sample size for each class to achieve the prediction accuracy without the bias. The method described herein includes balancing the sample size of different categories for the training set using the heuristic self training ML techniques to improve the accuracy and minimize the bias in the model.

In an embodiment, a vial coating inspection system for the cosmetic exterior coating quality of vials is provided. In an embodiment, the vials may be Valor Glass vials. The vial coating inspection system automatically evaluates the coating quality based on ML techniques. The quality ranking output separates out new vial samples into sub-categories and generates a set of standard coating quality samples for each category.

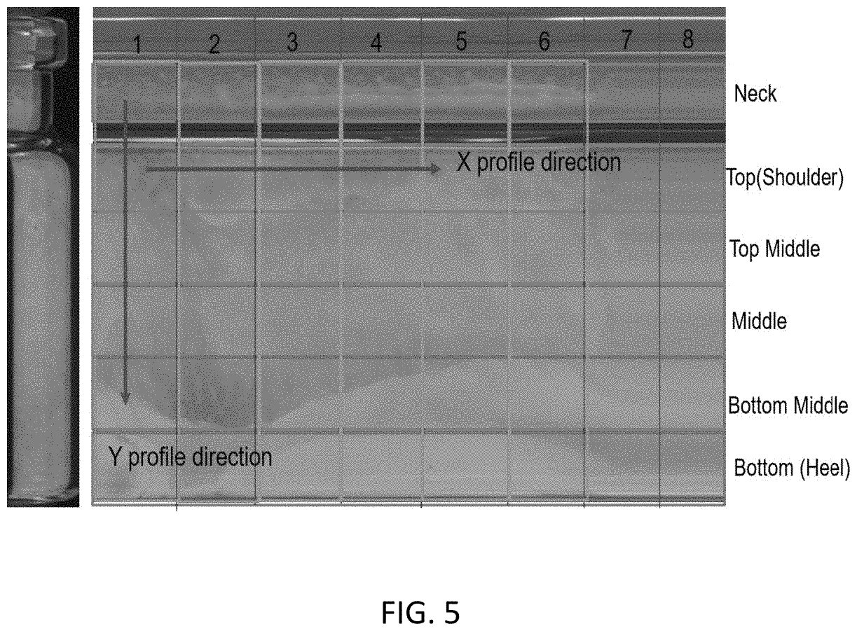

As described previously with respect to FIG. 4, Step 1 includes collection of the coating quality measurement data using the reflectance measurement system. The standard exterior coating quality metric values are measured for each block shown in FIG. 5. The measurement metric includes entropy, maximum intensity, minimum intensity, mean and standard deviation of intensity level, Ra, Rq, skewness and kurtosis. The ranking of training set was collected by the visual inspection of skilled operators.

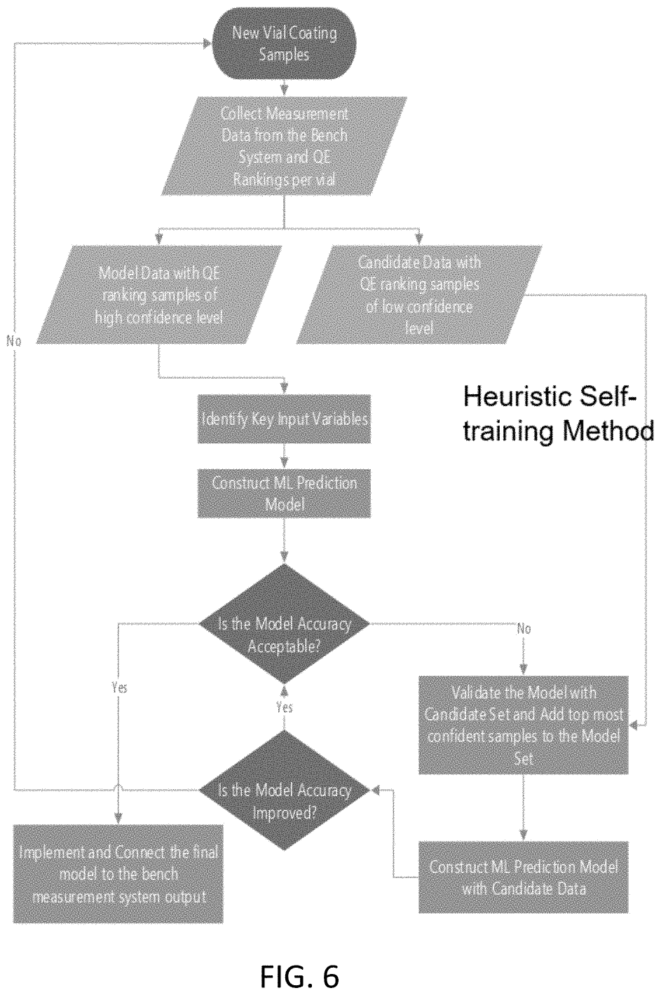

As described previously with respect to FIG. 4, Step 2 includes selection of training sample set and validation sample set for the classification model. In order to have the balanced training sample set for each category (for example, good, bad, or limit good), a heuristic self-training technique shown in FIG. 6 is implemented to increase the balanced sample size.

As described previously with respect to FIG. 4, Step 3 includes identification of key input variables from the measurement from the bench system for the prediction model accuracy. The input to the prediction model from the measurement system provides 9 different metric values in 48 sub areas of sliced image (or blocks, as shown in FIG. 5). In order to improve the accuracy of the prediction model, the key input variables must be identified. The techniques used to identify the key input variables include the backward comparison technique and the cross-correlation method.

As described previously with respect to FIG. 4, Step 4 includes development of the classification model for the specific vial type to map the relationship between the measurement from the optical measurement system and the pre-ranked category. Once the prediction model is constructed using the training set data with high accuracy, the system can generate the category of coating quality of new sample automatically applying the model developed.

As described previously with respect to FIG. 4, Step 5 includes extension of the classification model to different types of vial samples described in Step 4. Once the classification model is constructed for each type of vial sample, the final classification model for all vial types is constructed using ML ensemble techniques. The final ensemble prediction model can be applied to any types of samples with the same level of accuracy as in the individual classification model.

As described previously with respect to FIG. 4, Step 6 includes calculation of the final output by aggregating the probability of different columns (1 to 8) in the sliced image shown in FIG. 5 using an algorithm developed and described as systems and methods herein. The system generates the final probability of aggregated values, which allows a field engineer to adjust final ranking easily based on different user or customer expectations.

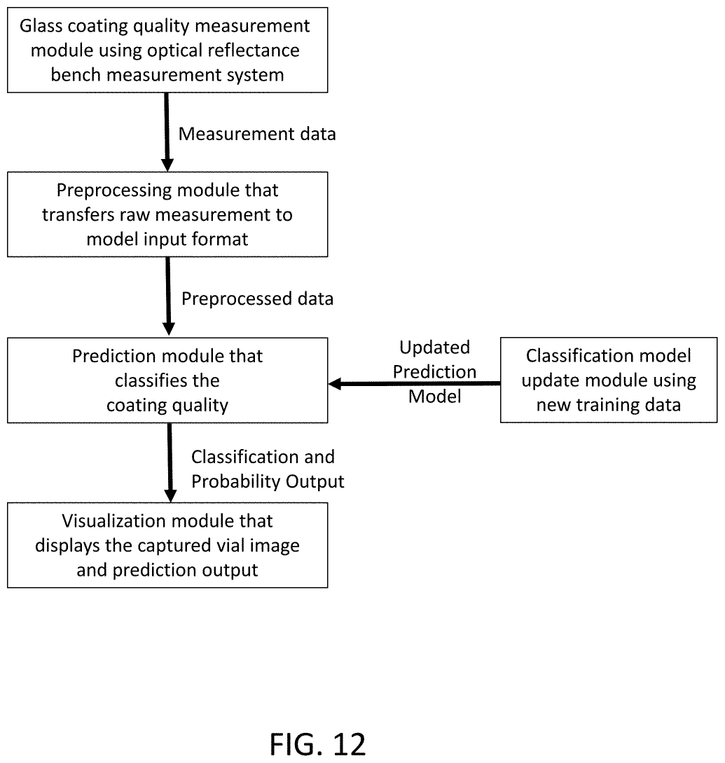

As described previously with respect to FIG. 4, Step 7 includes implementation of the inspection system with a visualization tool for the verification of the model output. The workflow that connects the input measurement from the bench system to the predicted quality output for vial samples is shown in FIG. 12.

Step 1: Collect Measurement Data and Ranking Data

The coating quality measurement data is collected using the spectral measurement system that mostly utilizes the spectral reflectance from the vial exterior surface. The standard exterior coating quality metric values are measured for each block shown in FIG. 5. The exterior coating quality metric values chosen for the measurement system include entropy, maximum intensity, minimum intensity, mean and standard deviation of intensity level, Ra, Rq, skewness and kurtosis through Gray, B, Gray scaled, and B scaled color channels. This follows the profile parameters that defines the surface roughness metrics recommended by ISO 4287. Other metric values that represent the coating quality of vial exterior surface can be added or removed based on the requirement for the different measurement system.

The measurement slicing per vial is done by 8 different columns across the vial circumference and 6 different regions from top to bottom per column as seen in FIG. 5. Each column contains the area of neck, top, top middle, middle, bottom middle and bottom region. The ranking of the training set is collected by the visual inspection of skilled operators. In order to minimize the impact of the uncertainty in operator's ranking that will directly affect the accuracy of the prediction model, the data set for the model should be chosen only for the consistently ranked samples.

Step 2: Select Training Set and Validation Set for Prediction Model Using Semi-Supervised Learning Technique

In order to have the unbiased classification result, it is important to have balanced number of samples for each class in training set. It is often much easier to get good quality coating samples than to get limit good quality samples or bad quality samples. First, the number of samples are determined by the minimum number of samples collected among categories. Once the set of samples are selected for the training set, the rest of samples become the candidate samples for the training set. The prediction model is constructed using the training set and the model is validated using the candidate set. Using the heuristic self-training method, which is one semi-supervised ML technique, the samples with high confidence level can be added to the original training set to increase the size of the balanced training set. FIG. 6 shows the workflow of the heuristic self training method. This process can be iterated until the desired amount of sample set is collected.

Step 3: Identify Key Input Variables (KIVs) Using ML Techniques

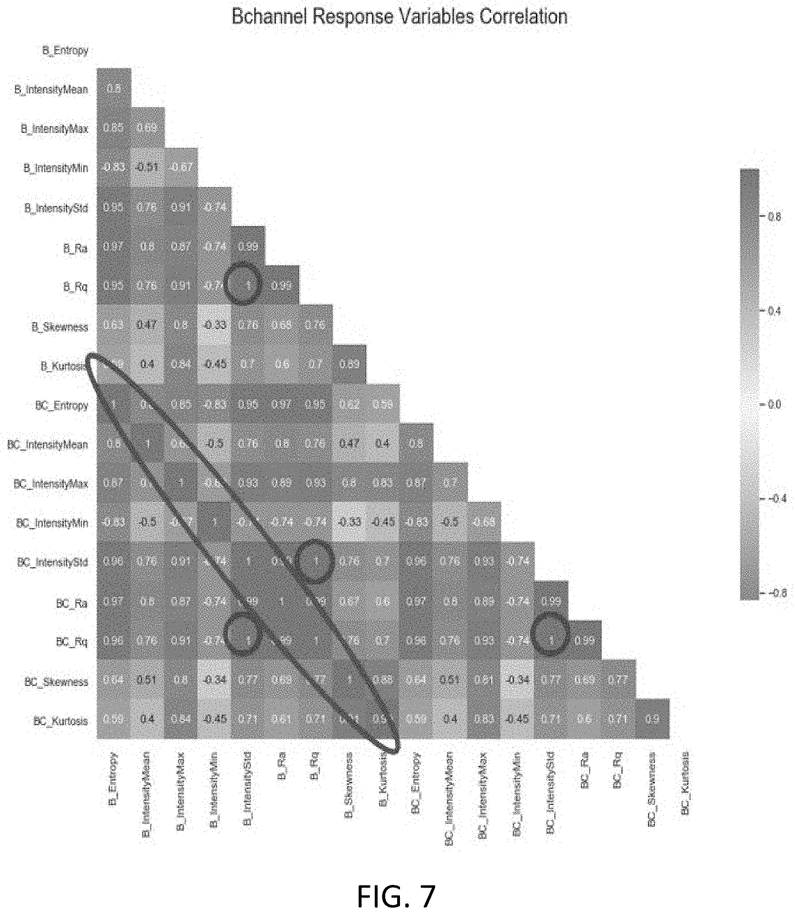

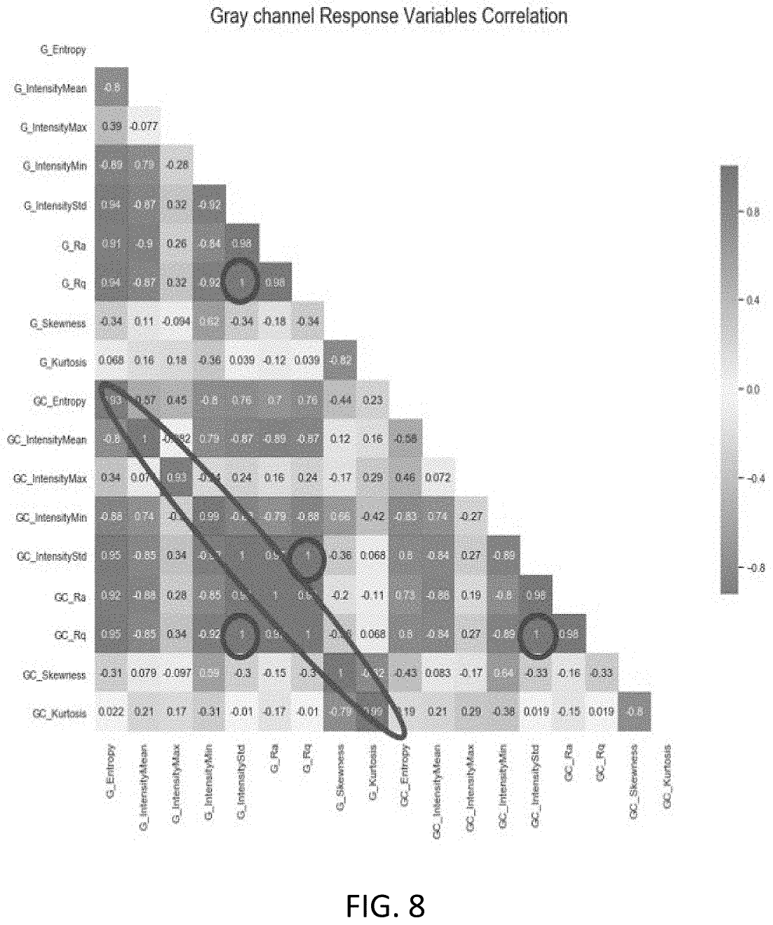

As described in the previous section, the input variables with different combination of regions, channels and cameras result in a large number of input variables for each column (ex) 648=9 metric values*6 different regions*5 different channels*3 different cameras). It is desirable to eliminate insignificant or redundant input variables that show the high correlation values to other variables. The input variables with high correlation values close to 1 can be eliminated to minimize overfitting problem in the model. FIG. 7 shows a graphical image of cross correlation of input variables for vial coating quality metric for the B channel, and FIG. 8 shows a graphical image of cross correlation of input variables for vial coating quality metric for the Gray channel. FIG. 7 and FIG. 8 show that input values measured from B channel and B channel scaled channel show high correlation value close to 1. It also shows that the direct correlation between the intensity standard value and the Rq value. The same goes to Ra and Rq metric values. Using the cross-correlation method, the number of redundant input variables are eliminated. (252=7 metric*2 channels*6 regions*3 camera). It turns out that the measurement from COSMOS field camera is sufficient to achieve the same level of model accuracy using 3 different cameras (bright field, dark field, and COSMOS field). Therefore, the input variables are reduced to 84. The key input variables are further determined using ML backward stepwise selection techniques. The model is iteratively constructed using the reduced number of input variables by examining both the feature importance ranking and the classification model accuracy. Table 1 shows the model accuracy with different selection of KIVs using Random Forest classification method. After several iterations, the final KIVs are systematically selected for the prediction model.

TABLE 1
Key Input Variables (KIV) selection vs. Prediction model accuracy

| Number of | | Prediction |
|---|---|---|
| Features | Input Feature Sets | Model Accuracy |
| 84 | 6 Regions, 2 channels (B and Gray), | 83.3% |
| | 7 variables (w/o Intensity Std and Ra) | |
| 42 | 3 Regions (Bottom, Bottom Middle, | 83.3% |
| | Middle), 2 channels, 7 variables | |
| 36 | 3 Regions (Bottom, Bottom Middle, | 83.7% |
| | Middle), 2 channels, 6 variables | |
| | (w/o Intensity Min) | |
| 28 | Excluding insignificant feature | 83.7% |
| | importance Gini value from 36 variables | |
| 17 | Final KIVs | 84.1% |

Step 4: Construct the Prediction Model Using ML Supervised Learning Technique

The prediction model (f) is based on the relationship Y=f(X), where Y represents the quality ranking, and X represents KIVs. The model is constructed for multiple classes (for example: good, bad, and limit good) using supervised ML learning techniques. In systems and methods herein, the ensemble tree methods such as Random Forest and XGBoost show the promising result. Both techniques show the similar feature importance rankings with the same level of accuracy (84.1% accuracy).

The results indicate that the rankings of vial coating quality for a certain region is affected by the measurement from the neighboring regions. For example, the ranking for the heel coating quality is determined by the bottom middle and the middle region, as well as the bottom region. It also shows that both Gray channel and B channel in the measurement system provide different levels of information for determining the coating quality of vial samples.

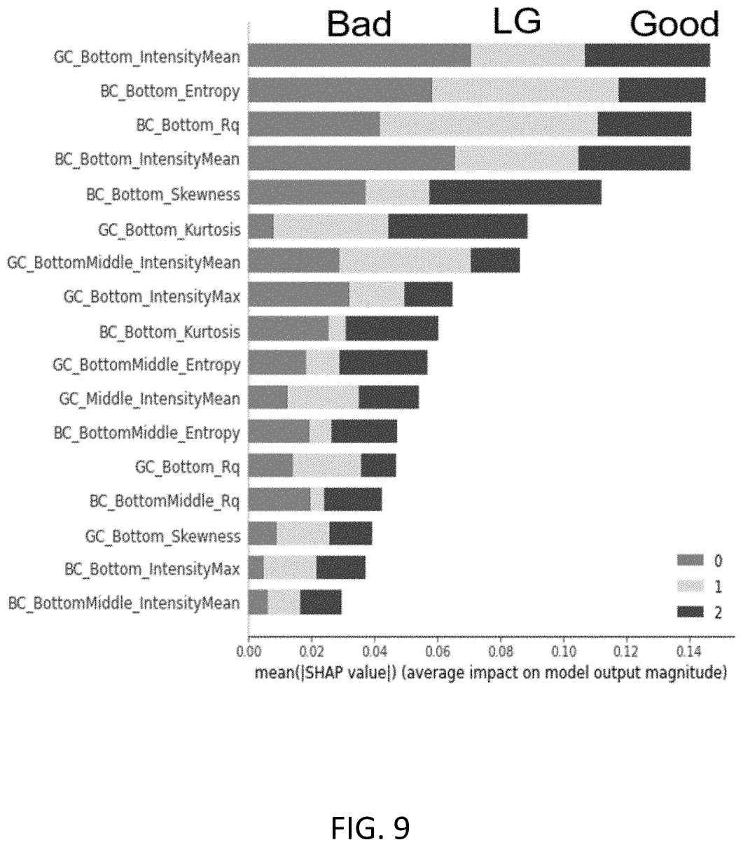

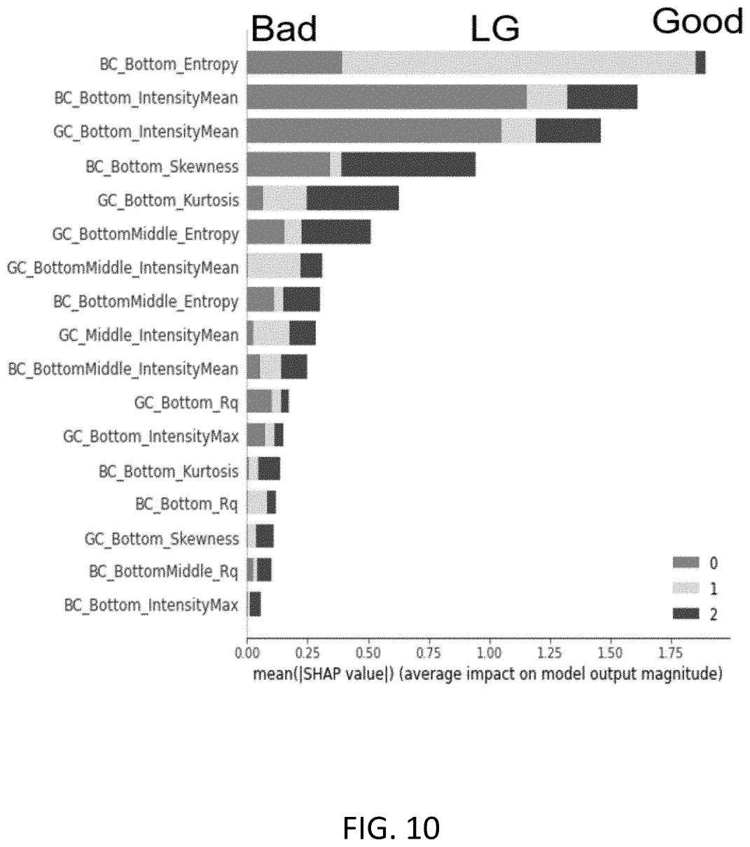

The prediction model can be explained as the distribution of each feature value of each sample using the ML SHAP technique. The Shap value is the average marginal contribution of a feature value across all possible combinations. In FIG. 9, the feature importance ranking using Shap value represents the average impact on Random Forest model output while in FIG. 10, the feature importance ranking using Shap value represents the average impact on XGBoost model output. As shown in both FIG. 9 and FIG. 10, input variables such as Intensity mean, entropy, Rq, skewness, and kurtosis values in the bottom region show high feature importance and impact on the prediction models.

Step 5: Extend the Prediction Model for all Types of Vials Using ML Ensemble Method

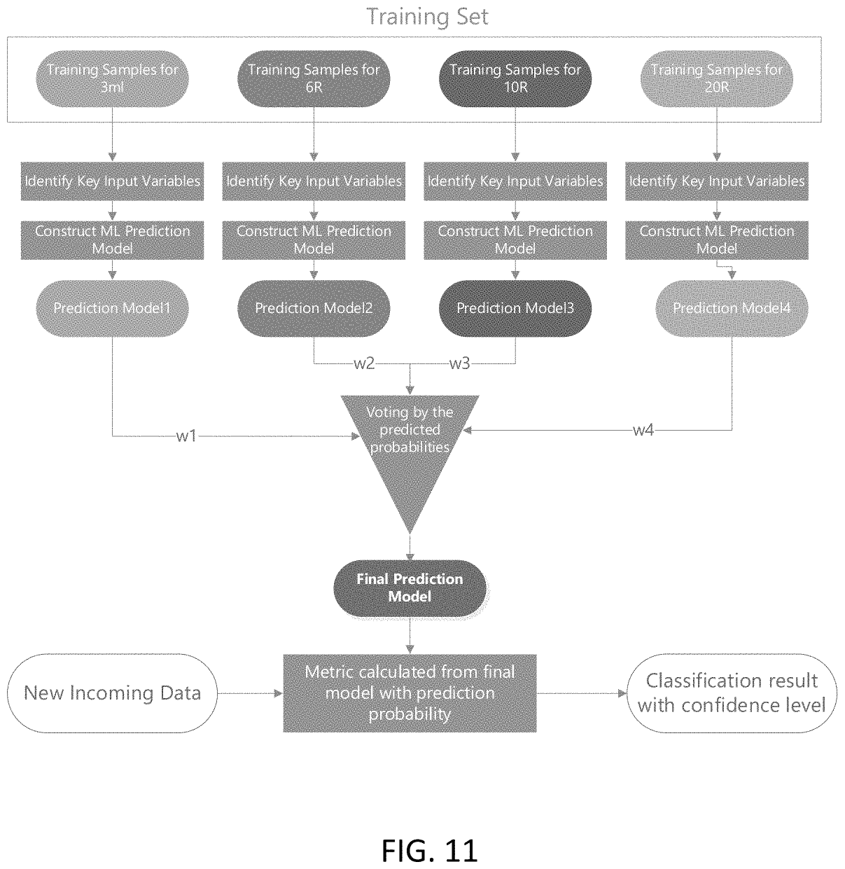

The final prediction model for all vial samples may be developed by constructing individual prediction model for each type, and statistically combining the probabilities of each model with different weights for the final prediction model. FIG. 11 shows the workflow of constructing a final ensemble prediction model.

Step 6: Calculation of Final Values with Aggregation Rules Developed

As shown in FIG. 5, one vial sample consists of 8 different columns. For the classification model, each column represents as an independent sample. A human may rank the quality of vials by inspecting the overall quality. Since it is unknown how a human ranks the overall quality, it is desirable to use each column as a different sample and aggregate the result later. This allows us to have more samples for the training model. After the prediction is done for each column, however, it is necessary to combine the rankings for different columns to a final ranking per vial. The prediction model outputs the predicted category and the probability (confidence level) for each column. Thus, the metric was developed to aggregate the prediction of each column to a final ranking of a vial sample. The algorithm is proposed as shown below.

For each sample k, the probability, Pₖ can be obtained by first getting the averaged probabilities of different categories, Pⱼ where P_{G} is the probability of good ranking, P_{B} is the probability of bad ranking, and P_{LG} is the probability of limit good ranking and then by identifying the maximum probability value.

$${P}_{k} = {argmax}_{i} ( {P}_{G} = {\sum }_{j = 1}^{6} {w}_{j} ( {p}_{j} \vert G ) , {P}_{L G} = {\sum }_{j = 1}^{6} {w}_{j} ( {p}_{j} \vert LG ) , {P}_{B} = {\sum }_{j = 1}^{6} {w}_{j} ( {p}_{j} \vert B ) )$$

If Pₖ is greater than a predefined threshold value (ex) 0.4), Pₖ becomes the final probability, P_{Final}. Here, the threshold value can be adjusted based on the specific requirement.

When there are more than one Pⱼ values (probability for each category, P_{G}, P_{B} and P_{LG}) that are greater than the threshold value, the maximum of Pⱼ value becomes P_{Final}.

If the Pⱼ value is smaller than the threshold value defined and the count of each category (Cⱼ) is equal, C_{G}=C_{B}=C_{LG}, the ranking is selected based on the summed probability where P_{Final}=Max(Pⱼ). When there are equal number of good (C_{G}) and bad (C_{B}) but no limit good ranking (C_{LG}=0) in prediction output, the ranking is selected based on one with the higher summed probability value

$${P}_{k} = {argmax}_{i} ( {P}_{G} , {P}_{B} ) .$$

This logic applies to equal number of limit good and bad or equal number of bad and limit good case.

Alternatively, if the Pⱼ value is smaller than the threshold value defined, a higher weight may be applied to the worse quality category. For example, the limit good ranking is selected when the probability for limit good is equal to the probability of good. The bad ranking is selected when the probability of bad is equal to the probability of limit good. The bad ranking is also selected when there are equal number of bad and good rankings.

Otherwise, P_{Final}=Max (Σⱼ₌₁⁶Cₖ).

Step 7: Implement the Automatic Inspection System with Visualization Tool

The implementation workflow is shown in FIG. 12. The data flow starts from the bench measurement system and ends with the final ranking output for new vial samples. A coating quality measurement module outputs the unformatted measurement data. A preprocessing module filters and aggregates this measurement data to the formatted data for the model generation and evaluation. A prediction module evaluates the coating quality of new vial samples based on the ML prediction model, wherein the prediction model is constructed using historic training data. An update module updates the prediction model using newly added training set data to improve the accuracy. A visualization module displays the scanned vial sample image with the prediction output and probabilities.

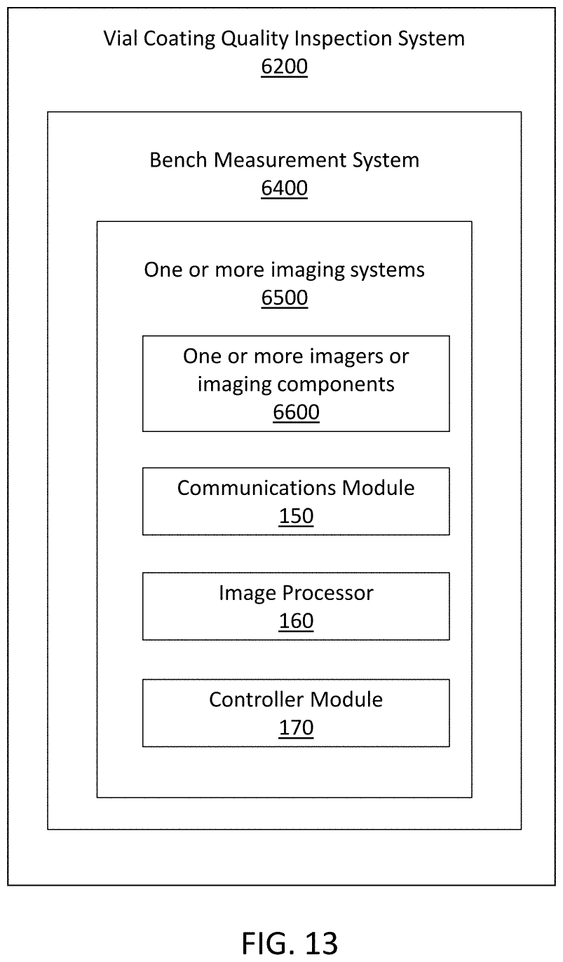

In an aspect, a vial coating quality inspection system 6200 is provided. The vial coating quality inspection system may be configured as a vial coating quality inspection system for inspection of manufactured pharmaceutical grade vials. An embodiment of the vial coating quality inspection system 6200 is shown in FIG. 13. The inspection system 6200 comprises a bench measurement system 6400. The bench measurement system 6400 comprises one or more imaging systems 6500 having one or more imaging components 6600. Each imaging component of the one or more imaging components 6600 may comprise a camera. The one or more imaging components 6600 may use optical reflectance.

Each of the one or more imaging systems 6500 of the inspection system 6200 may comprise an image processor 160 configured to receive image data transmitted from the one or more imaging components 6600. The imaging system 6500 may further include a communications module 150 configured to transfer images from the one or more imaging components 6600 to an image processor 160. As shown, each imaging system 6500 may further include a controller module 170 configured to control the various components of the imaging system 6500. For example, the controller module 170 may be configured to control the one or more imaging components 6600. The controller module 170 may also be configured to control one or both of the communications module 150 and the image processor 160.

The communication module 150 may be configured to communicate through a wired or wireless connection, including, but not limited to, a data connection conforming to one or more of the IEEE 802.11 family of standards (e.g., WiFi), a Bluetooth connection, a cellular network connection, an RF connection, a Universal Serial Bus (USB), an Ethernet connection, or any other data connection. The image processor 160 may be configured to record and analyze images received from the one or more imaging components 6600. The communications module 150 and image processor 160 may be on a single electronic device or multiple electronic devices, such as one or more desktop computers, laptop computers, tablet PCs, or other computer systems, as a user's particular setup of a vial coating quality inspection system of the present disclosure may require.

The controller module 170, communications module 150, and image processor 160 may interact so as to provide certain features to the imaging system 6500. For example, the system may be adapted to record the vial coating inspection image data (e.g., presence or absence of flaws or defects, locations of defects, depth of defects, etc.) in a non-transitory computer readable medium, and link the vial coating inspection image data with the region of the vial from which the data was extracted and/or the type of damage to the coating of the vial. The imaging system may provide additional functionality such as the ability to adjust the settings and parameters of the camera module, e.g., focal plane, aperture, shutter speed, sensitivity (e.g., ISO), white balance, etc. In some embodiments, the imaging system 6500 may be adapted to allow a user to record and/or analyze a vial coating quality inspection image or video. In other embodiments, the one or more imaging systems 6500 of the inspection system 6200 may communicate with a remote user device. The remote user device may be, e.g., a mobile phone device, a tablet computer, a desktop computer, a laptop computer or other computing system. The imaging systems 6500 may send one or more vial coating quality inspection images and/or associated data to the remote user device. In some embodiments, the remote user device may be adapted to control the one or more imaging systems 6500 of the inspection system 6200, such as by controlling the one or more imaging components 6600, including any of the functionality discussed above.

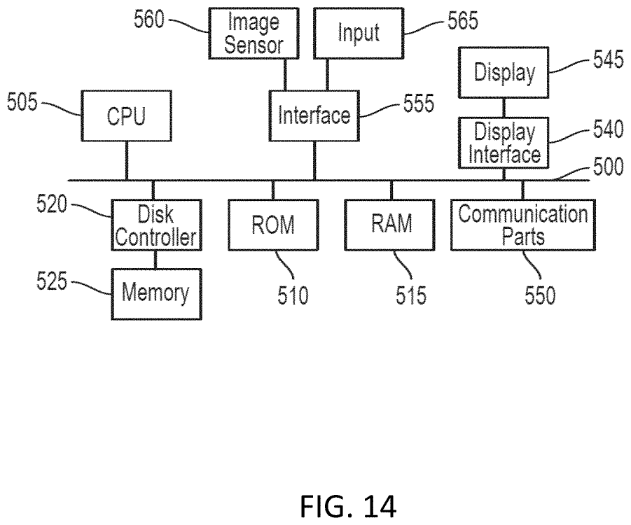

FIG. 14 depicts an example of internal hardware that may be used to contain or implement the various computer processes and systems as discussed herein. For example, the vial coating quality inspection system discussed herein may include mobile device hardware such as that illustrated in FIG. 14. An electrical bus 500 serves as an information highway interconnecting the other illustrated components of the hardware. CPU 505 is a central processing unit of the system, performing calculations and logic operations required to execute a program. CPU 505, alone or in conjunction with one or more of the other elements, is a processing device, computing device or processor as such terms are used within this disclosure. A CPU or “processor” is a component of an electronic device that executes programming instructions. The term “processor” may refer to either a single processor or to multiple processors that together implement various steps of a process. Unless the context specifically states that a single processor is required or that multiple processors are required, the term “processor” includes both the singular and plural embodiments. Read only memory (ROM) 510 and random-access memory (RAM) 515 constitute examples of memory devices. The term “memory device” and similar terms include single device embodiments, multiple devices that together store programming or data, or individual sectors of such devices.

A controller 520 interfaces with one or more optional memory devices 525 that serves as data storage facilities to the system bus 500. The memory devices 525 may include, for example, an external or internal disk drive, a hard drive, flash memory, a USB drive or another type of device that serves as a data storage facility. The various drives and controllers are optional devices. The memory devices 525 may be configured to include individual files for storing any software modules or instructions, auxiliary data, incident data, common files for storing groups of contingency tables and/or regression models, or one or more databases for storing the information as discussed above.

Program instructions, software or interactive modules for performing any of the functional steps associated with the processes as described above may be stored in the ROM 510 and/or the RAM 515. Optionally, the program instructions may be stored on a non-transitory, computer readable medium such as a compact disk, a digital disk, flash memory, a memory card, a USB drive, an optical disc storage medium, and/or other recording medium.

An optional display interface 540 may permit information from the bus 500 to be displayed on the display 545 in audio, visual, graphic or alphanumeric format. Communication with external devices may occur using various communication ports 550. A communication port 550 may be attached to a communications network, such as the Internet, a local area network or a cellular telephone data network. The hardware may also include an interface 555 which allows for receipt of data from input devices such as an imaging sensor 560 of a scanner or other input device 565 such as a keyboard, a mouse, a joystick, a touchscreen, a remote control, a pointing device, a video input device and/or an audio input device.

In a first (1) aspect, a vial coating inspection system is provided. The vial coating inspection system comprises a vial coating quality measurement system comprising: one or more imaging components for capturing images of a region of interest on a vial, the vial comprising a coating, and a processor configured to receive image data transmitted from the one or more imaging components.

In a second (2) aspect, in the system according to aspect 1, the coating comprises an exterior coating or a coating disposed on an exterior surface of the vial.

In a third (3) aspect, in the system according to any of aspect 1 or aspect 2, the vial coating inspection system ensures consistency in coating quality for manufactured vials.

In a fourth (4) aspect, in the system according to any of aspects 1 to 3, each imaging component of the one or more imaging components comprises a camera.

In a fifth (5) aspect, in the system according to aspect 4, each camera captures images of a region of interest on a manufactured vial.

In a sixth (6) aspect, in the system according to any of aspects 1 to 5, the vial is rotated about a central axis and images of the exterior coating of the vial are captured by the one or more imaging components.

In a seventh (7) aspect, in the system according to any of aspects 1 to 6, the region of interest on the vial comprises a neck of the vial.

In an eighth (8) aspect, in the system according to any of aspects 1 to 7, the region of interest on the vial comprises a shoulder of the vial.

In a ninth (9) aspect, in the system according to any of aspects 1 to 8, the region of interest on the vial comprises a sidewall top middle region of the vial.

In a tenth (10) aspect, in the system according to any of aspects 1 to 9, the region of interest on the vial comprises a sidewall middle region of the vial.

In an eleventh (11) aspect, in the system according to any of aspects 1 to 10, the region of interest on the vial comprises a sidewall bottom middle region of the vial.

In a twelfth (12) aspect, in the system of any of aspects 1 to 11, the region of interest on the vial comprises a heel of the vial.

In a thirteenth (13) aspect, in the system according to any of aspects 1 to 12, the vial is a pharmaceutical grade vial.

In a fourteenth (14) aspect, in the system according to aspect 13, the vial is a transparent glass vial.

In a fifteenth (15) aspect, in the system according to aspect 13, the vial is a transparent plastic vial.

In a sixteenth (16) aspect, in the system according to any of aspects 13 to 15, a size of the vial comprises an ISO format vial size or a custom format vial size.

In a seventeenth (17) aspect, in the system according to aspect 16, the ISO format vial size comprises a 2 R vial, 4 R vial, 6 R vial, 8 R vial, 10 R vial, 15 R vial, 20 R vial, 25 R vial, 30 R vial, 50 R vial, or 100 R vial.

In an eighteenth (18) aspect, in the system according to aspect 16, the custom format vial size comprises a 3 ml vial, 10 ml vial, or 25 ml vial.

In a nineteenth (19) aspect, in the system according to any of aspects 1 to 18, the vial coating quality measurement system comprises a bench measurement system.

In a twentieth (20) aspect, in the system according to aspect 19, the bench measurement system comprises filter techniques to evaluate coating and texture quality.

In a twenty-first (21) aspect, in the system according to aspect 20, the filter technique comprises a bright field filter technique.

In a twenty-second (22) aspect, in the system according to aspect 20, the filter technique comprises a dark field filter technique.

In a twenty-third (23) aspect, in the system according to aspect 20, the filter technique comprises a reflected filter technique.

In a twenty-fourth (24) aspect, a method of inspecting quality of an exterior coating on a vial is provided. The method comprises obtaining a coating quality measurement of the vial exterior coating using optical reflectance imaging; transmitting the raw coating quality measurement data to a processor; and displaying the captured vial image and classification and prediction output from the processor.

In a twenty-fifth (25) aspect, in the method according to aspect 24, the processor preprocesses the raw measurement data and inputs the preprocessed data to a classification prediction model.

In a twenty-sixth (26) aspect, in the method according to aspect 25, the method further comprises adjusting a threshold value that determines the sub-category of vial classification.

In a twenty-seventh (27) aspect, in the method according to any of aspects 24 to 26, the method further comprises updating the classification prediction model using training data.

In a twenty-eighth (28) aspect, in the method according to any of aspects 24 to 27, a machine learning based prediction model is used that is generated by pre-trained sample sets.

In a twenty-ninth (29) aspect, in the method according to any of aspects 24 to 28, the method further comprises classifying the coating quality based on the updated prediction model.

In a thirtieth (30) aspect, in the method according to any of aspects 24 to 29, the method further comprises outputting the classification and probability from the processor.

In a thirty-first (31) aspect, in the method according to any of aspects 24 to 30, the classification is selected from good, limit good, and bad.

In a thirty-second (32) aspect, in the method according to any of aspects 24 to 30, the classification comprises coating quality based on coating quality of different regions of the vial.

In a thirty-third (33) aspect, in the method according to any of aspects 24 to 30, the classification comprises coating quality based on coating defect type.

In a thirty-forth (34) aspect, in the method according to any of aspects 24 to 33, obtaining a coating measurement further comprises capturing images of a region of interest on a coated vial; applying a filter technique to create a filtered image using optical reflectance; and obtaining measurement data from the filtered image.

In a thirty-fifth (35) aspect, in the method according to any of aspects 24 to 34, the method further comprises categorizing vial coating quality without human visual inspection.

In a thirty-sixth (36) aspect, in the method according to any of aspects 24 to 35, the regions of interest are selected from the shoulder, the body and/or neck, and the heel of a vial.

In a thirty-seventh (37) aspect, in the method according to any of aspects 24 to 36, capturing images of the region of interest on the coated vial comprises capturing images while the vial rotates.

In a thirty-eighth (38) aspect, in the method according to aspect 37, the coated vial is positioned so that a bottom of the vial is in contact with a horizontal surface of a measurement system and the body of the vial is rotating 360 degrees about a cylindrical axis in a clockwise or counterclockwise manner.

In a thirty-ninth (39) aspect, in the method according to aspect 24, the measurement data comprises exterior coating quality metric values.

In a fortieth (40) aspect, in the method according to aspect 39, the exterior coating quality metric values comprise entropy, maximum intensity, minimum intensity, mean and standard deviation of intensity level, Ra, Rq, skewness, and kurtosis.

In a forty-first (41) aspect, in the method according to aspect 40, the exterior coating quality metric values are a function of color channels.

In a forty-second (42) aspect, in the method according to aspect 41, the color channels are selected from Gray channel, B channel, Gray scaled channel, B scaled channel, or a combination thereof.

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, refers to variation in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

“Optional” or “optionally” means that the subsequently described event or circumstance can or cannot occur, and that the description includes instances where the event or circumstance occurs and instances where it does not.

The indefinite article “a” or “an” and its corresponding definite article “the” as used herein means at least one, or one or more, unless specified otherwise.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, and like aspects, and ranges thereof, are for illustration only; they do not exclude other defined values or other values within defined ranges. The systems, kits, and methods of the disclosure can include any value or any combination of the values, specific values, more specific values, and preferred values described herein, including explicit or implicit intermediate values and ranges.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A vial coating inspection system comprising:
a vial coating quality measurement system comprising:
one or more imaging components for capturing images of one or more regions of interest on a vial, the vial comprising a coating, and
a processor configured to receive image data transmitted from the one or more imaging components,
wherein the one or more regions of interest are selected from a neck, a shoulder, a sidewall top middle region, a sidewall middle region, a sidewall bottom region, and a heel of the vial.

2. The system of claim 1, wherein the vial coating inspection system ensures consistency in coating quality for manufactured vials.

3. The system of claim 1, wherein each imaging component of the one or more imaging components comprises a camera.

4. The system of claim 3, wherein each camera captures images of a region of interest on a manufactured vial.

5. The system of claim 1, wherein the vial is rotated about a central axis and images of the exterior coating of the vial are captured by the one or more imaging components.

6. The system of claim 1, wherein the vial is a pharmaceutical grade vial.

7. The system of claim 6, wherein a size of the vial comprises an ISO format vial size or a custom format vial size.

8. The system of claim 1, wherein the vial coating quality measurement system comprises a bench measurement system.

9. The system of claim 8, wherein the bench measurement system comprises filter techniques to evaluate coating and texture quality.

10. The system of claim 9, wherein the filter technique comprises a bright field filter technique.

11. The system of claim 9, wherein the filter technique comprises a dark field filter technique.

12. The system of claim 9, wherein the filter technique comprises a reflected filter technique.

13. A method of inspecting quality of an exterior coating on a vial, the method comprising:
obtaining a coating quality measurement of the vial exterior coating using optical reflectance imaging;
transmitting the raw coating quality measurement data to a processor; and
displaying the captured vial image and classification and prediction output from the processor.

14. The method of claim 13, wherein the processor preprocesses the raw measurement data and inputs the preprocessed data to a classification prediction model.

15. The method of claim 14, further comprising adjusting a threshold value that determines the sub-category of vial classification.

16. The method of claim 13, further comprising updating the classification prediction model using training data.

17. The method of claim 13, wherein a machine learning based prediction model is used that is generated by pre-trained sample sets.

18. The method of claim 13, further comprising classifying the coating quality based on the updated prediction model.

19. The method of claim 13, wherein the classification comprises coating quality based on coating quality of different regions of the vial.

20. The method of claim 13, wherein the classification comprises coating quality based on coating defect type.

21. The method of claim 13, wherein obtaining a coating measurement further comprises:
capturing images of a region of interest on a coated vial;
applying a filter technique to create a filtered image using optical reflectance; and
obtaining measurement data from the filtered image.
